(19) United States
(12) Patent Application Publication
(10) Pub. No.: US 2026/0346211 A1
(43) Pub. Date: Nov. 5, 2026

(54) SEPARATION MEMBRANE, COMPOSITE MEMBRANE, AND METHOD FOR MANUFACTURING OF THE SEPARATION MEMBRANE

(71) Applicant: Samsung Electronics Co., Ltd., Suwon-si (KR)

(72) Inventors: Moon Joo LEE, Suwon-si (KR); Jong Geun Seong, Suwon-si (KR); JAI YOUNG CHUNG, Suwon-si (KR); EUNHA PARK, Suwon-si (KR)

(21) Appl. No.: 19/646,885

(22) Filed: Apr. 14, 2026

(30) Foreign Application Priority Data
Apr. 28, 2025 (KR) 10-2025-0055237
Jan. 6, 2026 (KR) 10-2026-0002120

(51) Int. Cl. B01D 69/14; B01D 69/10; B01D 69/12; B01D 71/52; B01D 71/70; B01D 71/80

(52) U.S. Cl. CPC B01D 69/1411; B01D 69/10; B01D 69/1216; B01D 71/52; B01D 71/70; B01D 71/80

(57) ABSTRACT

A separation membrane including a polymer matrix including a polymer including a first segment and a second segment having phase separation from each other, and having a plurality of pores, and an alkylene glycol oligomer positioned in the pores of the polymer matrix, wherein the alkylene glycol oligomer includes an alkylene oxide repeat unit substituted with a heterocyclic group including oxygen.

### CROSS-REFERENCE TO RELATED APPLICATIONS

This application claims priority to and the benefit of Korean Patent Application No. 10-2025-0055237 filed with the Korean Intellectual Property Office on Apr. 28, 2025, and Korean Patent Application No. 10-2026-0002120 filed with the Korean Intellectual Property Office on Jan. 6, 2026, and all the benefits accruing therefrom under 35 U.S.C. § 119, the contents of which in their entirety are herein incorporated by reference.

### BACKGROUND

The present disclosure relates to a separation membrane, a composite membrane, and a method of manufacturing the separation membrane.

Technologies to reduce emissions of carbon dioxide (CO₂) are being actively researched worldwide to respond to climate change problems such as global warming. As part of these efforts, various technologies for effectively capturing CO₂ are being developed, and representative examples thereof include wet scrubbing, dry sorbent, and cryogenic separation.

The wet scrubbing method is a commercialized technology and has the advantage of exhibiting high CO₂ capture efficiency. However, a large amount of thermal energy may be used in the process of desorbing absorbed CO₂, which may lower the energy efficiency of the entire system, and may lead to an increase in carbon capture costs. In addition, hazardous substances may be generated due to, for example, the corrosiveness and decomposition of the absorbent.

Membrane separation technology is a method of separating gas using a pressure difference, and is attracting attention as an eco-friendly and low-energy technology because energy consumption may be relatively low and harmful by-products are rarely or may not be generated. For the commercialization of membrane separation technology, the development of a separation membrane material having high performance is desired. For example, a separation membrane material capable of securing high gas permeability and selectivity may be an important factor in securing the economic feasibility of carbon capture.

Separation membranes used in membrane separation technology may be classified into solution-diffusion (SD)-based and facilitated transport-based. Polyether-based polymers based on or for use with the solution-diffusion mechanism may exhibit excellent CO₂ permeation performance and selectivity. As the content of ether groups in the polyether structure increases, the affinity with CO₂ may improve to provide high selectivity, but gas diffusion may be inhibited due to, for example, the formation of semi-crystalline domains, and the overall permeability may be lowered.

### SUMMARY

An aspect of the present disclosure provides a separation membrane capable of further improving gas permeability while maintaining gas selectivity by inducing a decrease in crystallinity of a polymer and formation of micropores, and securing long-term stability by blocking the possibility of elution of additives.

A separation membrane according to an aspect includes a polymer matrix including a polymer including a first segment and a second segment having phase separation from each other, and having a plurality of pores, and an alkylene glycol oligomer positioned in the pores of the polymer matrix, wherein the alkylene glycol oligomer includes an alkylene oxide repeat unit substituted with a heterocyclic group including oxygen.

The heterocyclic group including oxygen of the alkylene glycol oligomer may include an epoxy group, an oxetane group, tetrahydrofuran, 1,3-dioxolane, 1,4-dioxane, tetrahydropyran, or a combination thereof.

The alkylene oxide repeat unit of the alkylene glycol oligomer may include an ethylene oxide repeat unit, an n-propylene oxide repeat unit, an iso-propylene oxide repeat unit, an n-butylene repeat unit, or a combination thereof.

The alkylene glycol oligomer may be a compound represented by Chemical Formula 1.

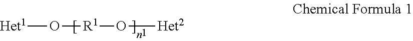

In Chemical Formula 1, R¹ is an alkylene group, Het¹ and Het² are each independently a heterocyclic group including oxygen, and n¹ is the number of repetitions of the repeat unit and may be an integer of 1 to 100.

The alkylene glycol oligomer may be a compound represented by Chemical Formula 1-1, 1-2, or 1-3.

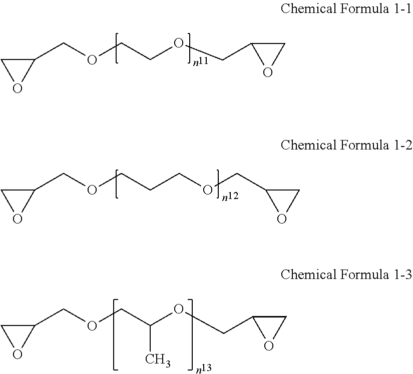

In Chemical Formulas 1-1 to 1-3, n¹¹ to n¹³ are the number of repetitions of each repeat unit, and may each independently be an integer of 1 to 100.

The separation membrane may include the alkylene glycol oligomer in an amount of greater than 0 weight percent (wt %) and less than or equal to 10 wt %, based on the total weight of the separation membrane.

The weight average molecular weight of the alkylene glycol oligomer may be 250 grams per mole (g/mol) to 1,000 g/mol.

The polymer of the polymer matrix may include poly(ethylene oxide)-block-poly(butylene terephthalate) (PEO-b-PBT), polyethylene oxide-block-polyamide (PEO-b-PA), poly(tetramethylene oxide)-block-polyamide (PTMO-b-PA), poly(acrylonitrile)-random-poly(ethylene glycol) methyl ether methacrylate (PAN-r-PEGMA), or a combination thereof.

The polymer of the polymer matrix may be a compound represented by Chemical Formula 2.

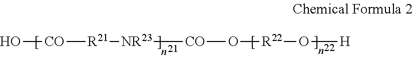

In Chemical Formula 2, R²¹ and R²² are each independently an alkylene group, R²³ is a hydrogen group or an alkyl group, n²¹ and n²² are molar ratios of the respective repeat units, the sum of n²¹ and n²² is 100, n²¹ is an integer of 10 to 60, and n²² may be an integer of 40 to 90.

A separation membrane according to an aspect includes a polymer matrix including a polymer including a first segment and a second segment having phase separation from each other, and having a plurality of pores, wherein a d-spacing, which is an average spacing between phase-separated domains measured by Small Angle X-ray Scattering (SAXS) analysis, may be less than 15.43 nanometers (nm).

The d-spacing of the separation membrane measured by Small Angle X-ray Scattering analysis may be greater than 10.58 nm and less than 15.43 nm.

The separation membrane may have a degree of crystallinity (Xc) of greater than or equal to 1.0% and less than 13.05%, calculated by Equation 1 using a result measured by differential scanning calorimetry (DSC).

X_{c}=ΔHₘ/ΔH_{m,0}×100% Equation 1

In Equation 1, Δ Hₘ is a melting enthalpy calculated from an area of a melting peak of a sample in the DSC result, and Δ H_{m,0} may be a theoretical melting enthalpy of a 100% crystalline polymer.

The separation membrane may have a fractional free volume (FFV) calculated by Equation 2 of greater than 0.115.

FFV=1−1.3·V_{ω}·ρ Equation 2

In Equation 2, V_{ω} is a van der Waals volume of a repeat unit of the polymer, and ρ is a density of the polymer.

The polymer of the polymer matrix may be a compound represented by Chemical Formula 2.

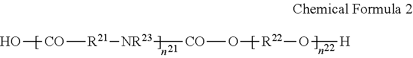

In Chemical Formula 2, R²¹ and R²² are each independently an alkylene group, R²³ is a hydrogen group or an alkyl group, n²¹ and n²² are molar ratios of respective repeat units, a sum of n²¹ and n²² is 100, n²¹ is an integer of 10 to 60, and n²² may be an integer of 40 to 90.

The separation membrane further includes an alkylene glycol oligomer positioned in the pores of the polymer matrix, and the alkylene glycol oligomer may include an alkylene oxide repeat unit substituted with a heterocyclic group including oxygen.

A composite membrane according to an aspect includes a porous support layer, an intermediate layer positioned on the porous support layer, and a separation membrane positioned on the intermediate layer, wherein the separation membrane is the disclosed separation membrane.

The intermediate layer includes polydimethylsiloxane (PDMS), poly(trimethylsilyl)propyne (PTMSP), or a combination thereof, and the intermediate layer may include a hydroxy radical (—OH) on a surface in contact with the separation membrane.

A method of manufacturing a separation membrane according to an aspect includes preparing a mixture by mixing a polymer including a first segment and a second segment having phase separation from each other with an alkylene glycol oligomer, forming a membrane using the mixture, and contacting the membrane with a solvent to remove at least a portion of the alkylene glycol oligomer to form a polymer matrix having a plurality of pores, wherein the alkylene glycol oligomer includes an alkylene oxide repeat unit substituted with a heterocyclic group including oxygen.

The mixture may include 10 parts by weight to 500 parts by weight of the alkylene glycol oligomer, based on 100 parts by weight of the polymer.

The solvent may include water, methanol, ethanol, propanol, butanol, or a combination thereof.

A separation membrane according to an aspect includes a polymer matrix including a polymer including a first segment and a second segment having phase separation from each other, and a plurality of pores; and an alkylene glycol oligomer positioned in the pores of the polymer matrix, wherein the alkylene glycol oligomer is a compound represented by Chemical Formula 1-3

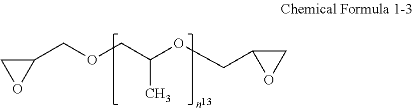

wherein n¹³ is an integer of 1 to 100, wherein the separation membrane includes the alkylene glycol oligomer in an amount of greater than 0 weight percent and less than or equal to 10 weight percent, based on the total weight of the separation membrane, and wherein the polymer of the polymer matrix includes polyethylene oxide-block-polyamide.

According to an embodiment, the separation membrane can additionally improve gas permeability while maintaining gas selectivity by inducing a decrease in crystallinity of the polymer and formation of micropores, and can ensure long-term stability by blocking the possibility of elution of additives.

### BRIEF DESCRIPTION OF THE DRAWINGS

The above and other advantages and features of this disclosure will become more apparent by describing in further detail exemplary embodiments thereof with reference to the accompanying drawings, in which:

FIG. 1 includes schematic diagrams showing a method of manufacturing a separation membrane according to an embodiment in a process sequence; and

FIG. 2 is a cross-sectional view schematically showing a composite membrane according to an embodiment.

### DETAILED DESCRIPTION OF THE EMBODIMENTS

Hereinafter, embodiments will be described in detail so that a person of ordinary skill in the art can easily implement them. However, actually applied structures may be implemented in various different forms and are not limited to implementations described herein.

In the drawings, thicknesses are enlarged to clearly illustrate various layers and regions. Throughout the specification, identical reference numerals are assigned to similar portions. When a portion such as a layer, a membrane, a region, or a plate is referred to as being “on” another portion, this includes not only a case where it is “directly on” the other portion but also a case where another portion is present therebetween. Conversely, when a portion is referred to as being “directly on” another portion, it means that there is no other portion therebetween.

The terminology used herein is for the purpose of describing particular embodiments only and is not intended to be limiting. As used herein, “a”, “an,” “the,” and “at least one” do not denote a limitation of quantity, and are intended to include both the singular and plural, unless the context clearly indicates otherwise. For example, “an element” has the same meaning as “at least one element,” unless the context clearly indicates otherwise. Thus, reference to “an” element in a claim followed by reference to “the” element is inclusive of one element and a plurality of the elements. “At least one” is not to be construed as limiting “a” or “an.” “Or” means “and/or.” As used herein, the term “and/or” includes any and all combinations of one or more of the associated listed items. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Hereinafter, unless defined otherwise, “substituted” means that a hydrogen atom in a compound is substituted with a substituent of a halogen atom, a hydroxy group, an alkoxy group, a nitro group, a cyano group, an amino group, an azido group, an amidino group, a hydrazino group, a hydrazono group, a carbonyl group, a carbamyl group, a thiol group, an ester group, a carboxyl group or a salt thereof, a sulfonic acid group or a salt thereof, phosphoric acid or a salt thereof, a silyl group, a C1 to C20 alkyl group, a C2 to C20 alkenyl group, a C2 to C20 alkynyl group, a C6 to C30 aryl group, a C7 to C30 arylalkyl group, a C1 to C30 alkoxy group, a C1 to C20 heteroalkyl group, a C3 to C20 heteroaryl group, a C3 to C20 heteroarylalkyl group, a C3 to C30 cycloalkyl group, a C3 to C15 cycloalkenyl group, a C6 to C15 cycloalkynyl group, a C3 to C30 heterocycloalkyl group, or a combination thereof.

Hereinafter, unless defined otherwise, an “alkyl group” refers to a substituted or unsubstituted linear or branched aliphatic hydrocarbon group. The alkyl group may be a “saturated alkyl group” that does not include a double bond or a triple bond.

For example, the alkyl group may be a C1 to C8 alkyl group, and for example, may be a C1 to C7 alkyl group, a C1 to C6 alkyl group, a C1 to C5 alkyl group, or a C1 to C4 alkyl group. For example, the C1 to C4 alkyl group may be a methyl group, an ethyl group, a propyl group, an isopropyl group, an n-butyl group, an isobutyl group, a sec-butyl group, a tert-butyl group, or a 2,2-dimethylpropyl group.

Unless defined otherwise, “alkylene group” refers to a substituted or unsubstituted linear or branched divalent hydrocarbyl group having a specific number of carbon atoms capable of connecting two different groups together. The alkylene group may refer to —(CH₂)ₙ— (wherein n is an integer of 1 to 8, and for example, n is an integer of 1 to 4).

For example, the alkylene group may be a C1 to C8 alkylene group, and for example, may be a C1 to C7 alkylene group, a C1 to C6 alkylene group, a C1 to C5 alkylene group, or a C1 to C4 alkylene group. For example, the C1 to C4 alkylene group may be a methylene group, an ethylene group, a propylene group, an isopropylene group, an n-butylene group, an isobutylene group, a sec-butylene group, a tert-butylene group, or a 2,2-dimethylpropylene group.

Unless defined otherwise, “heterocyclic group” refers to a cyclic aliphatic saturated hydrocarbon group including at least one heteroatom including N, O, S, P, Si, or a combination thereof in a cycloalkyl group. Two or more heterocyclic groups may be directly connected through a sigma bond, or when the heterocyclic group includes two or more rings, the two or more rings may be fused to each other. When the heterocyclic group is a fused ring, it may include 1 to 3 heteroatoms in each ring.

For example, the heterocyclic group may be a C3 to C20 heterocyclic group, for example, a C3 to C10 heterocyclic group, a C3 to C8 heterocyclic group, a C3 to C7 heterocyclic group, a C3 to C6 heterocyclic group, a C3 to C5 heterocyclic group, or a C3 to C4 heterocyclic group. For example, the heterocycloalkyl group may be pyrrolidine, tetrahydrofuran, tetrahydrothiophene, or piperidine, etc.

A separation membrane according to an embodiment includes a polymer matrix having a plurality of pores.

The polymer matrix has a plurality of pores in at least a portion thereof, and may selectively permeate gas for the purpose of separation or purification.

The polymer matrix may include any polymer material suitable for gas permeation, and may include a polymer material having chemical and electrical properties and affinity that facilitate selective separation of gas or dissolution in a solvent.

For example, when the gas is carbon dioxide (CO₂), the polymer matrix may include a polymer including a first, e.g., hard, segment and a second, e.g., soft, segment having phase separation from each other. The polymer having phase separation may improve gas permeability while maintaining gas selectivity. In some embodiments, the first segment may have a relatively higher glass transition temperature (Tg) compared to the second segment. For example, the first segment may be a crystalline or glassy segment. In contrast, the second segment may have a relatively lower glass transition temperature (Tg) compared to the first segment. For example, the second segment may be an amorphous or rubbery segment.

For example, the polymer having phase separation may include poly(ethylene oxide)-block-poly(butylene terephthalate) (PEO-b-PBT), polyethylene oxide-block-polyamide (PEO-b-PA), poly(tetramethylene oxide)-block-polyamide (PTMO-b-PA), poly(acrylonitrile)-random-poly(ethylene glycol) methyl ether methacrylate (PAN-r-PEGMA), or a combination thereof.

For example, the polyethylene oxide-block-polyamide may include a hard segment of polyamide and a soft segment of poly(ethylene oxide), and the hard segment of polyamide and the soft segment of poly(ethylene oxide) may have phase separation from each other.

For example, the polymer having phase separation may be a compound represented by Chemical Formula 2.

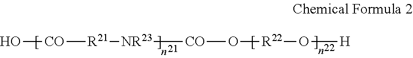

In Chemical Formula 2, R²¹ and R²² may each independently be an alkylene group. For example, R²¹ and R²² may each independently be an ethylene group, an n-propylene group, or an iso-propylene group.

In Chemical Formula 2, R²³ may be a hydrogen group or an alkyl group. The alkyl group may be a substituted or unsubstituted linear or branched alkyl group having 1 to 8 carbon atoms, and may be, for example, a methyl group, an ethyl group, a propyl group, an isopropyl group, an n-butyl group, an isobutyl group, a sec-butyl group, a tert-butyl group, or a 2,2-dimethylpropyl group.

In Chemical Formula 2, n²¹ and n²² are molar ratios of respective repeat units, the sum of n²¹ and n²² is 100, n²¹ may be an integer of 10 to 60, for example, an integer of 20 to 50, an integer of 30 to 50, or an integer of 30 to 40, and n²² may be an integer of 40 to 90, for example, an integer of 50 to 80, an integer of 50 to 70, or an integer of 60 to 70.

The separation membrane may further include an alkylene glycol-based oligomer. The alkylene glycol-based oligomer may be added to the separation membrane as a pore-forming agent, and form pores in the polymer matrix by a portion of the alkylene glycol-based oligomer being removed, and a remaining portion of the alkylene glycol-based oligomer may remain in the separation membrane.

For example, as described herein, the separation membrane may include a polymer matrix having a plurality of pores formed by preparing a mixture by mixing a polymer and an alkylene glycol-based oligomer, forming a membrane using the mixture, and contacting the membrane with a solvent to remove at least a portion of the alkylene glycol-based oligomer. A portion of the alkylene glycol-based oligomer remaining, e.g., without being removed, may be positioned in the pores of the polymer matrix. The alkylene glycol-based oligomer may be positioned on one surface or both surfaces of the polymer matrix, or may be mixed with the polymer of the polymer matrix and positioned inside the polymer matrix.

For example, the main chain of the alkylene glycol-based oligomer, that is, the alkylene oxide repeat unit, may include an ethylene oxide repeat unit, an n-propylene oxide repeat unit, an iso-propylene oxide repeat unit, an n-butylene repeat unit, or a combination thereof.

For example, the alkylene glycol-based oligomer may include polyethylene glycol, polyethylene glycol methyl ether methacrylate, polyethylene glycol diacrylate, polyethylene glycol methacrylate, polyethylene glycol methyl ether, polyethylene glycol dimethacrylate, polypropylene glycol, polypropylene glycol methacrylate, polypropylene glycol dimethacrylate, polypropylene glycol acrylate, polypropylene glycol diacrylate, polypropylene glycol bis(2-aminopropyl ether), or a combination thereof.

The alkylene glycol-based oligomer may include an alkylene oxide repeat unit substituted with a heterocyclic group including oxygen. When the alkylene glycol-based oligomer has a bulky substituent such as a heterocyclic group including oxygen, it may induce formation of micropores in the polymer matrix, and since the oxygen of the heterocyclic group forms an additional hydrogen bond with the polymer of the polymer matrix but does not form a chemical bond such as a covalent bond, gas permeability may be further improved while maintaining gas selectivity. For example, the heterocyclic group including oxygen of the alkylene glycol-based oligomer may include an epoxy group, an oxetane group, tetrahydrofuran, 1,3-dioxolane, 1,4-dioxane, tetrahydropyran, or a combination thereof.

For example, the alkylene glycol-based oligomer may be a compound represented by Chemical Formula 1.

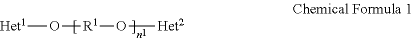

In Chemical Formula 1, R¹ may be an alkylene group. For example, R¹ may be an ethylene group, an n-propylene group, or an iso-propylene group.

In Chemical Formula 1, Het¹ and Het² may each independently be a heterocyclic group including oxygen. For example, Het¹ and Het² may each independently include an epoxy group, an oxetane group, tetrahydrofuran, 1,3-dioxolane, 1,4-dioxane, tetrahydropyran, or a combination thereof.

In Chemical Formula 1, n¹ is the number of repetitions of the repeat unit, may be adjusted according to the weight average molecular weight of the alkylene glycol-based oligomer, and may be, for example, an integer of 1 to 100, an integer of 1 to 20, an integer of 7 to 8, or an integer of 5 to 6.

For example, the alkylene glycol-based oligomer may be a compound represented by Chemical Formula 1-1, 1-2, or 1-3.

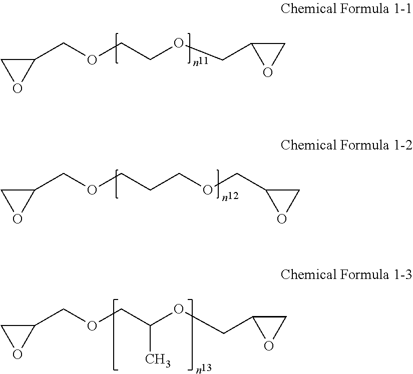

In Chemical Formulas 1-1 to 1-3, n¹¹ to n¹³ are the number of repetitions of each repeat unit, may be adjusted according to the weight average molecular weight of the alkylene glycol-based oligomer, and may each independently be an integer of 1 to 100, for example, an integer of 1 to 20, an integer of 7 to 8, or an integer of 5 to 6.

The weight average molecular weight of the alkylene glycol-based oligomer may be 250 g/mol or greater, for example, 300 g/mol or greater, 400 g/mol or greater, 500 g/mol or greater, 600 g/mol or greater, 700 g/mol or greater, 800 g/mol or greater, or 900 g/mol or greater, may be 1,000 g/mol or less, for example, 900 g/mol or less, 800 g/mol or less, 700 g/mol or less, 600 g/mol or less, 500 g/mol or less, 400 g/mol or less, or 300 g/mol or less, and may be 250 g/mol to 1,000 g/mol. When the weight average molecular weight of the alkylene glycol-based oligomer is greater than 1,000 g/mol, selectivity may decrease due to, for example, defects of the pores in the polymer matrix, and long-term stability may deteriorate as the alkylene glycol-based oligomer is eluted.

As described herein, the alkylene glycol-based oligomer is added to the separation membrane as a pore-forming agent, and forms pores in the polymer matrix as a portion of the alkylene glycol-based oligomer is removed, and since a remaining portion of the alkylene glycol-based oligomer may remain in the separation membrane, the separation membrane may include a small amount of the alkylene glycol-based oligomer. The separation membrane may include the alkylene glycol-based oligomer in an amount of greater than 0 wt %, based on the total weight of the separation membrane, for example, 0.01 wt % or greater, 0.02 wt % or greater, 0.03 wt % or greater, 0.04 wt % or greater, 0.05 wt % or greater, 0.06 wt % or greater, 0.07 wt % or greater, 0.08 wt % or greater, 0.09 wt % or greater, 0.1 wt % or greater, 0.2 wt % or greater, 0.3 wt % or greater, 0.4 wt % or greater, 0.5 wt % or greater, 0.6 wt % or greater, 0.7 wt % or greater, 0.8 wt % or greater, 0.9 wt % or greater, 1 wt % or greater, 2 wt % or greater, 3 wt % or greater, 4 wt % or greater, 5 wt % or greater, 6 wt % or greater, 7 wt % or greater, 8 wt % or greater, or 9 wt % or greater, may include the alkylene glycol-based oligomer in an amount of 10 wt % or less, for example, 9 wt % or less, 8 wt % or less, 7 wt % or less, 6 wt % or less, 5 wt % or less, 4 wt % or less, 3 wt % or less, 2 wt % or less, 1 wt % or less, 0.5 wt % or less, 0.1 wt % or less, 0.05 wt % or less, or 0.01 wt % or less, and may include the alkylene glycol-based oligomer in an amount of greater than 0 wt % and less than or equal to 10 wt %.

As described herein, the separation membrane may be manufactured by using an alkylene glycol-based oligomer including a heterocyclic group including oxygen as a pore-forming agent, preparing a mixture by mixing a polymer and the alkylene glycol-based oligomer including the heterocyclic group including oxygen, forming a membrane using the mixture, and contacting the membrane with a solvent to remove at least a portion of the alkylene glycol-based oligomer including the heterocyclic group including oxygen, forming a polymer matrix having a plurality of pores.

When the alkylene glycol-based oligomer has a bulky substituent such as the heterocyclic group including oxygen, it may induce the formation of micropores in the polymer matrix, and gas permeability may be additionally improved while maintaining gas selectivity because oxygen of the heterocyclic group forms an additional hydrogen bond with the polymer of the polymer matrix but does not form a chemical bond such as a covalent bond.

In the separation membrane, a d-spacing, which is an average spacing between phase separation domains measured by Small Angle X-ray Scattering (SAXS) analysis, may be smaller than in a separation membrane including a polymer matrix including a polymer including a hard segment and a soft segment having phase separation from each other and a plurality of pores and lacking an alkylene glycol-based oligomer including an alkylene oxide repeat unit substituted with a heterocyclic group comprising oxygen (also referred to herein as “a general case”). For example, the separation membrane manufactured using the alkylene glycol-based oligomer including the heterocyclic group including oxygen as a pore-forming agent may have a d-spacing of less than 15.43 nm, for example, less than or equal to 14.0 nm, less than or equal to 13.0 nm, less than or equal to 12.0 nm, or less than or equal to 11.48 nm, may be greater than 10.58 nm, for example, greater than or equal to 10.92 nm, greater than 11.1 nm, or greater than or equal to 11.48 nm, and may be greater than 10.58 nm and less than 15.43 nm, for example, greater than or equal to 10.92 nm and less than 15.43 nm, 10.92 nm to 11.48 nm, or greater than 11.1 nm and less than or equal to 11.48 nm.

The Small Angle X-ray Scattering analysis may be performed using Outstanding SAXSess equipment equipped with a Cu Kα x-ray source under conditions of 50 kilovolts (kV) and 0.6 milliamperes (mA).

The separation membrane may have a degree of crystallinity (X_{c}), calculated by Equation 1 using a result measured by differential scanning calorimetry (DSC), that is smaller than in a general case. The separation membrane manufactured using the alkylene glycol-based oligomer including a heterocyclic group including oxygen as a pore-forming agent may have a degree of crystallinity (X_{c}) of less than 13.05%, for example, less than or equal to 13.0%, less than or equal to 12.0%, less than or equal to 11.48%, less than or equal to 11.0%, less than or equal to 10.72%, less than or equal to 10.0%, less than or equal to 9.0%, less than or equal to 8.0%, or less than or equal to 7.0%, may be greater than or equal to 1.0%, for example, greater than or equal to 1.5%, greater than or equal to 2.0%, greater than or equal to 2.5%, greater than or equal to 3.0%, greater than or equal to 3.5%, greater than or equal to 4.0%, greater than or equal to 4.5%, greater than or equal to 5.0%, greater than or equal to 5.5%, greater than or equal to 6.0%, greater than 6.20%, or greater than 10.72%, and may be greater than or equal to 1.0% and less than 13.05%, for example, 1.0% to 11.48%, greater than 6.20% and less than or equal to 11.48%, or greater than 10.72% and less than or equal to 11.48%.

X_{c}=ΔHₘ/ΔH_{m,0}×100% Equation 1

In Equation 1, Δ Hₘ is a melting enthalpy calculated from an area of a melting peak of a sample in the DSC result, and Δ H_{m,0} is a theoretical melting enthalpy of a 100% crystalline polymer.

The differential scanning calorimetry may be performed using a DSC (TA Discovery, TA) instrument under conditions of heating from room temperature (for example, 20 °C) to 250 °C at a rate of 5 °C/minute (min) in a nitrogen atmosphere.

The separation membrane may have a fractional free volume (FFV) greater than in a general case. For example, when the polymer included in the polymer matrix is polyethylene oxide-block-polyamide, a general fractional free volume of a separation membrane may be about 0.1025. The separation membrane manufactured using the alkylene glycol-based oligomer including the heterocyclic group including oxygen as a pore-forming agent may have a fractional free volume of greater than 0.115, for example, greater than or equal to 0.15, greater than or equal to 0.2, greater than or equal to 0.25, greater than or equal to 0.3, or greater than or equal to 0.35, may be less than or equal to 0.4, for example, less than or equal to 0.35, less than or equal to 0.3, less than or equal to 0.25, less than or equal to 0.20, or less than or equal to 0.15, and may be greater than 0.115 and less than or equal to 0.4, or 0.2 to 0.3.

The fractional free volume may be calculated by Equation 2.

FFV=1−1.3·V_{ω}·ρ Equation 2

In Equation 2, V_{ω} is a van der Waals volume of a repeat unit of the polymer, and ρ is a density of the polymer.

For example, when the polymer is polyethylene oxide-block-polyamide, the polymer may include 60% of —[O(CH₂)₂]— repeat units and 40% of —[CO—(CH₂)₅—NH]— repeat units, and the van der Waals volumes of the repeat units may be calculated by Bondi's group contribution method.

In a separation membrane according to an embodiment, a polymer matrix having a plurality of pores may be formed by mixing a polymer and an alkylene glycol-based oligomer to prepare a mixture, forming a membrane using the mixture, and contacting the membrane with a solvent to remove at least a portion of the alkylene glycol-based oligomer.

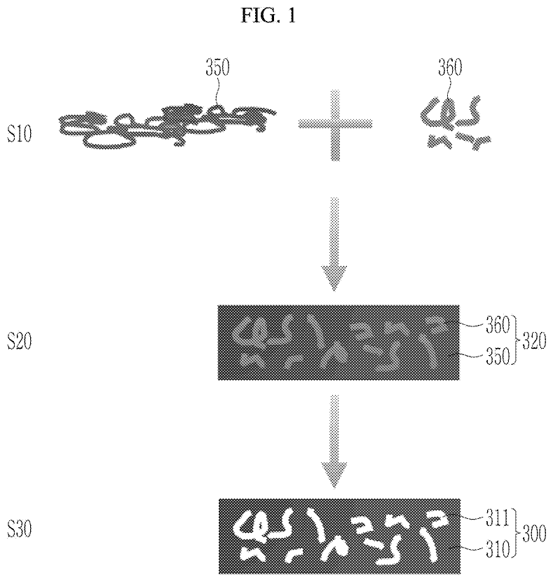

FIG. 1 is schematic diagrams showing a method of manufacturing a separation membrane according to a process sequence. Hereinafter, the method of manufacturing a separation membrane will be described with reference to FIG. 1.

First, a polymer 350 and an alkylene glycol-based oligomer 360 are mixed to prepare a mixture S10. The alkylene glycol-based oligomer 360 may include an alkylene oxide repeat unit substituted with a heterocyclic group including oxygen. Descriptions of the polymer 350 and the alkylene glycol-based oligomer 360 are the same as described herein, and repetitive descriptions will be omitted.

For example, the mixture may include the alkylene glycol-based oligomer 360 in an amount of 10 parts by weight or greater, based on 100 parts by weight of the polymer 350, for example, 50 parts by weight or greater, 100 parts by weight or greater, 200 parts by weight or greater, 300 parts by weight or greater, or 400 parts by weight or greater, may include the alkylene glycol-based oligomer 360 in an amount of 500 parts by weight or less, for example, 400 parts by weight or less, 300 parts by weight or less, 200 parts by weight or less, 100 parts by weight or less, or 50 parts by weight or less, and may include the alkylene glycol-based oligomer 360 in an amount of 10 parts by weight to 500 parts by weight. When the amount of the alkylene glycol-based oligomer 360 is greater than 500 parts by weight, the amount of the polymer 350 is not sufficient, a phase-separated polymer matrix 310 may not be formed, the alkylene glycol-based oligomer 360 may be eluted, and deteriorating long-term stability may be deteriorated. When the amount of the alkylene glycol-based oligomer 360 is less than 10 parts by weight, the amount of the alkylene glycol-based oligomer 360 is not sufficient to form the polymer matrix 310 having a plurality of pores, and gas permeation performance may be deteriorated.

The mixture may further include a solvent for membrane formation capable of dissolving both the polymer 350 and the alkylene glycol-based oligomer 360. The solvent for membrane formation can dissolve both the polymer 350 and the alkylene glycol-based oligomer 360, and may include, for example, water, ethanol, methanol, butanol, propanol, or a combination thereof, and may include a mixed solution of water and ethanol. A mixing ratio when water and ethanol are mixed may be 10:90 to 50:50, based on weight, and may be, for example, 20:80 to 40:60, or 30:70. Dissolution of the polymer 350 may be performed in a state where a temperature of the solvent for membrane formation is increased to assist dissolution of the polymer 350.

Next, a membrane 320 is formed using the mixture S20.

Forming the membrane 320 using the mixture may include a method of manufacturing a single membrane form by casting only the mixture, or manufacturing a composite membrane form by immersing or coating the mixture on a support.

For example, a method of forming the membrane 320 using the mixture may use spin coating, roll coating, dip coating, bar coating, flow coating, or spray coating. For example, when using bar coating, which facilitates large-area formation, the mixture may be bar-coated at a speed of 5 millimeters per second (mm/s) to 100 mm/s at a temperature of 25 °C to 90 °C. When the temperature of the bar coating is less than 25 °C, evaporation of the solvent for membrane formation in the mixture is reduced, and curing of the membrane 320 may be delayed, and when the temperature is greater than 90 °C, defects may occur in the membrane 320 due to, for example, immediate volatilization of the solvent for membrane formation.

In the formed membrane 320, the polymer 350 including a hard segment and a soft segment having phase separation from each other and the alkylene glycol-based oligomer 360 are mixed.

Next, the separation membrane 300 may be manufactured by contacting the membrane 320 with a solvent to remove at least a portion of the alkylene glycol-based oligomer 360 to form a polymer matrix 310 having a plurality of pores 311 S30.

As the solvent capable of removing at least a portion of the alkylene glycol-based oligomer 360 from the membrane 320, a solvent capable of dissolving a component of the alkylene glycol-based oligomer 360 to extract and remove the component due to, for example, having chemical and electrical properties similar to those of the alkylene glycol-based oligomer 360 may be used. For example, the solvent capable of removing at least a portion of the alkylene glycol-based oligomer 360 may include water or an alcohol, and may include, for example, water, methanol, ethanol, propanol, butanol, or a combination thereof.

The contact between the membrane 320 and the solvent for removing at least a portion of the alkylene glycol-based oligomer 360 may be performed at 25 °C to 40 °C, which is a room temperature environment. The contact between the membrane 320 and the solvent may use an immersion method in which the membrane 320 is immersed in a liquid solvent for process ease, and for example, the membrane 320 may be immersed in an immersion tank including the solvent having a temperature of 25 °C to 40 °C for 1 second to 60 seconds. When the temperature of the solvent is less than 25 °C, the elution and removal rate of the alkylene glycol-based oligomer 360 may decrease, and when the temperature of the solvent is greater than 40 °C, the polymer 350 as well as the alkylene glycol-based oligomer 360 may be partially dissolved.

A composite membrane according to an embodiment may include a porous support layer, an intermediate layer, and a separation membrane.

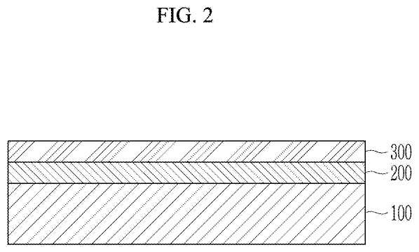

FIG. 2 is a cross-sectional view schematically showing the composite membrane. Hereinafter, the composite membrane will be described with reference to FIG. 2.

For example, the composite membrane may have a structure in which a porous support layer 100, an intermediate layer 200, and a separation membrane 300 are sequentially stacked.

The porous support layer 100 serves to provide mechanical strength to the separation membrane 300.

For example, the porous support layer 100 may include polyacrylonitrile (PAN), polysulfone (PSF), polyethersulfone (PES), polyvinylidene fluoride (PVDF), polyimide, polyetherimide (PEI), polyamide (PA), cellulose acetate, cellulose triacetate, or a combination thereof. For example, when the porous support layer includes polyacrylonitrile, since polyacrylonitrile is insoluble in various organic solvents such as tetrahydrofuran, chloroform, and 1,4-dioxane, the range of material selection for the intermediate layer 200 and the separation membrane 300 may be widened.

The thickness of the porous support layer 100 may be 30 micrometers (μm) to 50 μm. When the thickness of the porous support layer 100 is less than 30 μm, mechanical strength may be low and the structure may be damaged, and when the thickness of the porous support layer 100 is greater than 50 μm, permeation resistance of the porous support layer 100 may increase.

The intermediate layer 200 is positioned between the porous support layer 100 and the separation membrane 300 serving as a separation membrane, and the separation membrane 300 may be prevented from penetrating into pores of the porous support layer 100 and gas permeability of the separation membrane 300 may be increased.

For example, the intermediate layer 200 may include polydimethylsiloxane (PDMS), poly(trimethylsilyl)propyne (PTMSP), or a combination thereof.

When the intermediate layer 200 includes polydimethylsiloxane, a surface of the intermediate layer 200 may be hydrophilically treated to form the separation membrane 300 by forming the membrane using the mixture on the intermediate layer 200 and contacting the membrane with the solvent to remove at least a portion of the alkylene glycol-based oligomer, and the polymer matrix having a plurality of pores may be formed. For example, a method of hydrophilizing the surface of the intermediate layer 200 may use plasma treatment.

During the plasma treatment, a voltage may be 1 kV to 50 kV, a reaction pressure may be medium vacuum (0.1 pascals (Pa)) or greater and atmospheric pressure (100 kilopascals (kPa)) or less, and a frequency may be 1 kilohertz (kHz) to 100 kHz, for example. A separation distance between the electrode portions may be 4 mm to 150 mm, and an electric field of 1 kV/centimeter (cm) to 15 kV/cm may be applied to the discharge region.

The plasma reaction portion may use, for example, a discharge method such as dielectric barrier discharge, corona discharge, radio frequency (RF) glow discharge, or microwave induced plasma. A plasma reaction portion to which pulsed power is applied may be included. The surface of the intermediate layer 200 hydrophilized by the plasma treatment may include a hydroxy radical (—OH).

The thickness of the intermediate layer 200 may be 30 nm to 1,000 nm. When the thickness of the intermediate layer 200 is less than 30 nm, the intermediate layer 200 may not properly perform a role of preventing pore penetration of the separation membrane 300 or increasing permeability, and when the thickness is greater than 1,000 nm, permeation resistance of the intermediate layer 200 may increase.

The separation membrane 300 may include the separation membrane described herein. For example, the separation membrane 300 may be manufactured by using the alkylene glycol-based oligomer including the heterocyclic group including oxygen as a pore-forming agent, preparing the mixture by mixing the polymer and the alkylene glycol-based oligomer including the heterocyclic group including oxygen, forming the membrane using the mixture, and contacting the membrane with the solvent to remove at least a portion of the alkylene glycol-based oligomer including the heterocyclic group including oxygen, forming the polymer matrix having a plurality of pores.

The separation membrane 300 may include a small amount of the alkylene glycol-based oligomer including the heterocyclic group including oxygen, the d-spacing, which is an average spacing between phase-separated domains measured by Small Angle X-ray Scattering (SAXS) analysis, may be greater than in a general case, the degree of crystallinity (Xc) calculated by Equation 1 using a result measured by differential scanning calorimetry (DSC) may be smaller than in a general case, and the separation membrane may have the fractional free volume (FFV) greater than in a general case. Other descriptions of the separation membrane 300 are the same as the description of the separation membrane described herein, and repeated descriptions are omitted.

Hereinafter, the above-described embodiments will be described in more detail through experimental examples. However, the following examples are for illustrative purposes only and do not limit the scope of rights.

### Preparation Example: Preparation of Composite Membrane

### Examples 1 to 8

A polymer solution was prepared by stirring 3 weight percent (wt %) of a polyethylene oxide-block-polyamide (PEBAX 1657) polymer in a mixed solvent of ethanol and water (70 volume percent (vol %) ethanol, 30 vol % water) at 80 °C for 4 hours while refluxing. In addition, an oligomer solution was prepared by diluting an alkylene glycol-based oligomer (n¹³ in Chemical Formula 1-3: 1 to 4, weight average molecular weight: 380 grams per mole (g/mol)) to 3 wt % in a mixed solvent of ethanol and water (70 vol % ethanol, 30 vol % water). A mixture was prepared by further adding the oligomer solution to the polymer solution in an oligomer addition amount (parts by weight of the oligomer, based on 100 parts by weight of the polymer) listed in Table 1.

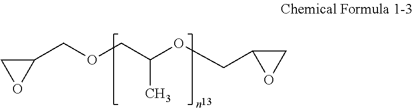

Poly(trimethylsilyl)propyne (PTMSP) was coated as an intermediate layer on a porous polysulfone support. After the porous support coated with the intermediate layer was mounted on bar coating equipment, the mixture was placed thereon, and then bar coating was performed at a speed of 40 mm/s at 60 °C using a coating bar to form a membrane. This membrane was dried at 60 °C.

The membrane mixed with the alkylene glycol-based oligomer was immersed in an immersion tank including ethanol at room temperature for a solvent immersion time (seconds) listed in Table 1, and then dried at 60 °C for 4 hours to prepare a composite membrane from which the alkylene glycol-based oligomer was removed.

### Example 9

A polymer solution was prepared by stirring 3 wt % of a polyethylene oxide-block-polyamide (PEBAX 1657) polymer in a mixed solvent of ethanol and water (70 vol % ethanol, 30 vol % water) at 80 °C for 4 hours while refluxing. In addition, an oligomer solution was prepared by diluting an alkylene glycol-based oligomer (n¹³ in Chemical Formula 1-3: 1 to 4, weight average molecular weight: 380 g/mol) to 3 wt % in a mixed solvent of ethanol and water (70 vol % ethanol, 30 vol % water). A mixture was prepared by further adding the oligomer solution to the polymer solution in an oligomer addition amount (parts by weight of the oligomer, based on 100 parts by weight of the polymer) listed in Table 1.

The polydimethylsiloxane surface of a porous polysulfone support coated with polydimethylsiloxane (PDMS) as an intermediate layer was subjected to plasma treatment under oxygen and helium gas inflow conditions using vacuum corona discharge equipment, and then the porous polysulfone support was mounted on bar coating equipment. The mixture was placed on the porous support, and then bar coating was performed at a speed of 40 millimeters per second (mm/s) at 60 °C using a coating bar to form a membrane. This membrane was dried at 60 °C.

The membrane mixed with the alkylene glycol-based oligomer was immersed in an immersion tank including ethanol at room temperature for a solvent immersion time (seconds) listed in Table 1, and then dried at 60 °C to prepare a composite membrane from which the alkylene glycol-based oligomer was removed.

### Comparative Example 1

A polymer solution was prepared by stirring and dissolving 3 wt % of a polyethylene oxide-block-polyamide (PEBAX 1657) polymer in a mixed solvent of ethanol and water (70 vol % ethanol, 30 vol % water) at 80 °C for 4 hours while refluxing.

After mounting a porous polysulfone support coated with poly(trimethylsilyl)propyne (PTMSP) as an intermediate layer on bar coating equipment, the polymer solution was placed thereon, and then bar coating was performed using a coating bar at a speed of 40 mm/s at 60 °C to prepare a composite membrane. This membrane was dried at 60 °C.

### Comparative Example 2

A polymer solution was prepared by stirring 3 wt % of a polyethylene oxide-block-polyamide (PEBAX 1657) polymer in a mixed solvent of ethanol and water (70 vol % ethanol, 30 vol % water) at 80 °C for 4 hours while refluxing. In addition, an oligomer solution was prepared by diluting an alkylene glycol-based oligomer (n¹³ in Chemical Formula 1-3: 1 to 4, weight average molecular weight: 380 g/mol) to 3 wt % in a mixed solvent of ethanol and water (70 vol % ethanol, 30 vol % water). A mixture was prepared by further adding the oligomer solution to the polymer solution in an oligomer addition amount (parts by weight of the oligomer, based on 100 parts by weight of the polymer) listed in Table 1.

After mounting a porous polysulfone support coated with poly(trimethylsilyl)propyne (PTMSP) as an intermediate layer on bar coating equipment, the mixture was placed thereon, and then bar coating was performed using a coating bar at a speed of 40 mm/s at 60 °C to prepare a composite membrane. This membrane was dried at 60 °C.

### Comparative Example 3

A polymer solution was prepared by stirring 3 wt % of a polyethylene oxide-block-polyamide (PEBAX 1657) polymer in a mixed solvent of ethanol and water (70 vol % ethanol, 30 vol % water) at 80 °C for 4 hours while refluxing. In addition, a mixture was prepared by further adding a polypropylene glycol oligomer (weight average molecular weight: 200 g/mol) to the polymer solution in an oligomer addition amount (parts by weight) listed in Table 1.

A composite membrane was manufactured by mounting a porous polysulfone support coated with poly(trimethylsilyl)propyne (PTMSP) as an intermediate layer on bar coating equipment, placing the mixture on the porous support, and then performing bar coating using a coating bar at a speed of 40 mm/s at 60 °C. This membrane was dried at 60 °C.

### Comparative Example 4

A polymer solution was prepared by stirring 3 wt % of a polyethylene oxide-block-polyamide (PEBAX 1657) polymer in a mixed solvent of ethanol and water (70 vol % ethanol, 30 vol % water) at 80 °C for 4 hours while refluxing. In addition, a mixture was prepared by further adding a polyethylene glycol oligomer (weight average molecular weight: 200 g/mol) to the polymer solution in an oligomer addition amount (parts by weight of the oligomer, based on 100 parts by weight of the polymer) listed in Table 1.

A membrane was formed by mounting a porous polysulfone support coated with poly(trimethylsilyl)propyne (PTMSP) as an intermediate layer on bar coating equipment, placing the mixture on the surface, and then performing bar coating using a coating bar at a speed of 40 mm/s at 60 °C. This membrane was dried at 60 °C.

A composite membrane from which the polyethylene glycol oligomer was removed was manufactured by immersing the membrane mixed with the polyethylene glycol oligomer in an immersion tank including ethanol at room temperature for a solvent immersion time (seconds) listed in Table 1, and then drying it at 60 °C.

### Comparative Example 5

A polymer solution was prepared by refluxing and stirring 1.5 wt % of a polyethylene oxide-block-polyamide (PEBAX 1657) polymer in a mixed solvent of ethanol and water (70 vol % ethanol, 30 vol % water) at 80 °C for 4 hours.

A composite membrane was manufactured by mounting a porous polysulfone support coated with poly(trimethylsilyl)propyne (PTMSP) as an intermediate layer on bar coating equipment, placing the polymer solution on the porous support, and then bar-coating it using a coating bar at a speed of 40 mm/s at 60 °C. The membrane was dried at 60 °C.

### Comparative Example 6

A polymer solution was prepared by refluxing and stirring 1.5 wt % of a polyethylene oxide-block-polyamide (PEBAX 1657) polymer in a mixed solvent of ethanol and water (70 vol % ethanol, 30 vol % water) at 80 °C for 4 hours.

A composite membrane was manufactured by mounting a porous polysulfone support coated with poly(trimethylsilyl)propyne (PTMSP) as an intermediate layer on bar coating equipment, placing the polymer solution on the porous support, and then bar-coating it using a coating bar at a speed of 40 mm/s at 60 °C. The membrane was dried at 60 °C.

The prepared composite membrane was immersed in an immersion tank including ethanol, immersed at room temperature for a solvent immersion time (seconds (sec)) listed in Table 1, and then dried at 60 °C.

### Comparative Examples 7 to 9

A composite membrane was prepared in the same manner as in Comparative Example 2, except that the addition amount of the alkylene glycol-based oligomer was changed to the oligomer addition amount (parts by weight) listed in Table 1.

### Comparative Example 10

A polymer solution was prepared by refluxing and stirring 3 wt % of a polyethylene oxide-block-polyamide (PEBAX 1657) polymer in a mixed solvent of ethanol and water (70 vol % ethanol, 30 vol % water) at 80 °C for 4 hours. In addition, an oligomer solution was prepared by diluting an alkylene glycol-based oligomer (n¹³ in Chemical Formula 1-3: 1 to 4, weight average molecular weight: 380 g/mol) to 3 wt % in a mixed solvent of ethanol and water (70 vol % ethanol, 30 vol % water). A mixture was prepared by further adding the oligomer solution to the polymer solution in an oligomer addition amount (parts by weight of the oligomer, based on 100 parts by weight of the polymer) listed in Table 1.

The polydimethylsiloxane surface of a porous polysulfone support coated with polydimethylsiloxane (PDMS) as an intermediate layer was plasma-treated under oxygen and helium gas inflow conditions using vacuum corona discharge equipment, and then the porous polysulfone support was mounted on bar coating equipment. The mixture was placed on the porous support, and then bar coating was performed using a coating bar at a speed of 40 mm/s at 60 °C to prepare a composite membrane. The membrane was dried at 60 °C.

TABLE 1

| | | | Oligomer | | |
|---|---|---|---|---|---|
| | Polymer | | addition | | Presence |
| | addition | | amount | Solvent | of |
| Classifi- | amount | Oligomer | (parts by | immersion | pretreat- |
| cation | (wt %) | type | weight) | time (sec) | ment |
| Example 1 | 3 | Chemical | 100 | 30 | None |
| | | Formula | | | |
| | | 1-3 | | | |
| Example 2 | 3 | Chemical | 50 | 30 | None |
| | | Formula | | | |
| | | 1-3 | | | |
| Example 3 | 3 | Chemical | 200 | 30 | None |
| | | Formula | | | |
| | | 1-3 | | | |
| Example 4 | 3 | Chemical | 500 | 30 | None |
| | | Formula | | | |
| | | 1-3 | | | |
| Example 5 | 3 | Chemical | 100 | 15 | None |
| | | Formula | | | |
| | | 1-3 | | | |
| Example 6 | 3 | Chemical | 100 | 45 | None |
| | | Formula | | | |
| | | 1-3 | | | |
| Example 7 | 3 | Chemical | 100 | 60 | None |
| | | Formula | | | |
| | | 1-3 | | | |
| Example 8 | 3 | Chemical | 100 | 180 | None |
| | | Formula | | | |
| | | 1-3 | | | |
| Example 9 | 3 | Chemical | 100 | 30 | Plasma |
| | | Formula | | | treatment |
| | | 1-3 | | | |
| Comparative | 3 | None | 0 | None | None |
| Example 1 | | | | | |
| Comparative | 3 | Chemical | 100 | None | None |
| Example 2 | | Formula | | | |
| | | 1-3 | | | |
| Comparative | 3 | Polyethylene | 100 | None | None |
| Example 3 | | Glycol | | | |
| | | (PEG) | | | |
| Comparative | 3 | PEG | 100 | 30 | None |
| Example 4 | | | | | |
| Comparative | 1.5 | None | 0 | None | None |
| Example 5 | | | | | |
| Comparative | 1.5 | None | 0 | 30 | None |
| Example 6 | | | | | |
| Comparative | 3 | Chemical | 50 | None | None |
| Example 7 | | Formula | | | |
| | | 1-3 | | | |
| Comparative | 3 | Chemical | 200 | None | None |
| Example 8 | | Formula | | | |
| | | 1-3 | | | |
| Comparative | 3 | Chemical | 500 | None | None |
| Example 9 | | Formula | | | |
| | | 1-3 | | | |
| Comparative | 3 | Chemical | 100 | None | Plasma |
| Example 10 | | Formula | | | treatment |
| | | 1-3 | | | |

### Experimental Example 1: Characteristics of Prepared Composite Membrane

The d-spacing measured by Small Angle X-ray Scattering (SAXS) analysis and the degree of crystallinity (X_{c}) measured by differential scanning calorimetry (DSC) were determined for the composite membranes prepared in the Examples and Comparative Examples, and the results are listed in Tables 2 to 4.

The Small Angle X-ray Scattering analysis was performed using Outstanding SAXSess equipment equipped with a Cu Kα x-ray source under conditions of 50 kV and 0.6 mA.
2) The differential scanning calorimetry was performed using DSC (TA Discovery, TA) equipment under conditions of heating from room temperature (for example, 20 °C) to 250 °C at a rate of 5 °C/minute (min) in a nitrogen atmosphere.

TABLE 2

| Classification | d-spacing (nanometers (nm)) |
|---|---|
| Comparative Example 1 | 11.1 |
| Comparative Example 2 | 15.43 |
| Comparative Example 3 | 15.43 |
| Comparative Example 6 | 11.1 |

Referring to Table 2, it can be confirmed that Comparative Example 1 and Comparative Example 6 have a low d-spacing as the alkylene glycol-based oligomer was not added.

It can be confirmed that in Comparative Example 2, the d-spacing significantly increases as the alkylene glycol-based oligomer (Chemical Formula 1-3) is added but the alkylene glycol-based oligomer is not removed, and in Comparative Example 3, the d-spacing significantly increases as the alkylene glycol-based oligomer (PEG) is added but the alkylene glycol-based oligomer is not removed.

TABLE 3

| Classification | d-spacing (nm) |
|---|---|
| Example 1 | 10.92 |
| Example 2 | 11.48 |
| Comparative Example 4 | 10.58 |

Referring to Table 3, it can be confirmed that in Comparative Example 4, the d-spacing significantly increases as the oligomer (PEG) is added, like in Comparative Example 3, and then the d-spacing significantly decreases again as the oligomer is removed.

On the other hand, it can be confirmed that in Examples 1 and 2, the d-spacing significantly increases as the alkylene glycol-based oligomer (Chemical Formula 1-3) is added, like in Comparative Example 2, but the d-spacing does not significantly decrease again like in Comparative Example 4 even after the alkylene glycol-based oligomer is removed.

TABLE 4

| Category | Crystallinity(%) |
|---|---|
| Example 1 | 11.48 |
| Comparative Example 4 | 13.05 |

Referring to Table 4, it can be confirmed that in Example 1, as the alkylene glycol-based oligomer (Chemical Formula 1-3) is added and then removed, the degree of crystallinity is lower compared to Comparative Example 4 in which the oligomer (PEG) is added and then removed.

In other words, referring to Tables 2 to 4, it can be seen that the composite membrane prepared in Example 1 has a greater d-spacing, which is an average spacing between phase-separated domains measured by Small Angle X-ray Scattering (SAXS) analysis, and a smaller degree of crystallinity (Xc) calculated by Equation 1 using a result measured by differential scanning calorimetry (DSC), compared to the composite membrane prepared in Comparative Example 4.

Therefore, it can be seen that when the alkylene glycol-based oligomer has a bulky substituent such as a heterocyclic group including oxygen, it can induce formation of micropores in the polymer matrix, and the oxygen of the heterocyclic group forms an additional hydrogen bond with the polymer of the polymer matrix but does not form a chemical bond such as a covalent bond.

### Experimental Example 2: Performance of Prepared Composite Membranes

Each of the composite membranes prepared in the Examples and Comparative Examples was sampled to have an area of 7.065 square centimeters (cm²), and then mounted on a permeation cell.

After supplying CO₂ and N₂ gases at 2 bar, respectively, the amount of permeated gas was measured using a bubble soap flowmeter, and the gas permeability of the composite membrane was calculated using Equation 2 by determining the amount of permeated gas per second (cubic centimeters per second (cm³/sec)), and GPU was used as the unit.

Gas permeability(P/I)=Permeation amount(cm³/s)/(Membrane area(cm²)×Pressure(cm·Hg)) Equation 2

GPU=10⁻⁶ cm³/(s·cm²·cm·Hg)

The CO₂ permeability, N₂ permeability, and CO₂/N₂ selectivity of the composite membranes prepared in the Examples and Comparative Examples are listed in Table 5.

TABLE 5

| | CO₂ Permeance | N₂ Permeance | |
|---|---|---|---|
| Classification | (GPU) | (GPU) | CO₂/N₂ Selectivity |
| Example 1 | 1,932 | 81 | 24.0 |
| Example 2 | 923 | 20 | 45.1 |
| Example 3 | 1,794 | 87 | 20.5 |
| Example 4 | 7,246 | 1,341 | 5.4 |
| Example 5 | 1,465 | 65 | 22.4 |
| Example 6 | 1,261 | 42 | 30.0 |
| Example 7 | 1,415 | 50 | 28.5 |
| Example 8 | 1,839 | 76 | 24.1 |
| Example 9 | 997 | 87 | 11.5 |
| Comparative | 246 | 7 | 37.3 |
| Example 1 | | | |
| Comparative | 459 | 15 | 29.7 |
| Example 2 | | | |
| Comparative | 461 | 14 | 32.4 |
| Example 3 | | | |
| Comparative | 837 | 29 | 28.9 |
| Example 4 | | | |
| Comparative | 596 | 18 | 33.0 |
| Example 5 | | | |
| Comparative | 1,183 | 37 | 32.0 |
| Example 6 | | | |
| Comparative | 587 | 15 | 38.3 |
| Example 7 | | | |
| Comparative | 471 | 16 | 30.2 |
| Example 8 | | | |
| Comparative | 1,221 | 72 | 16.9 |
| Example 9 | | | |
| Comparative | 628 | 18 | 35.1 |
| Example 10 | | | |

Comparing Comparative Example 1, Comparative Example 2, and Example 1 of Table 5, it can be seen that the gas permeability of Comparative Example 2 is improved by about 1.9 times compared to Comparative Example 1 as it includes the alkylene glycol-based oligomer. It can be seen that the CO₂ permeability of Example 1 is improved by 7.9 times compared to Comparative Example 1 and by 4.2 times compared to Comparative Example 2, as the alkylene glycol-based oligomer is removed by immersion in ethanol.

Comparing Comparative Example 2 and Comparative Example 3 of Table 5, it can be seen that the CO₂ permeability of Comparative Example 2, to which Chemical Formula 1-3 was added as the alkylene glycol-based oligomer, is similar to that of Comparative Example 3, to which the compound represented by PEG was added.

However, comparing Comparative Example 4 and Example 1 from which the alkylene glycol-based oligomer was removed, it can be seen that the CO₂ permeability of Example 1 using the compound represented by Chemical Formula 1-3 as the alkylene glycol-based oligomer is improved by 2.3 times compared to Comparative Example 4. Through this, it can be confirmed that when the alkylene glycol-based oligomer has a bulky substituent such as a heterocyclic group including oxygen, it may induce the formation of micropores in the polymer matrix, and since the oxygen of the heterocyclic group forms an additional hydrogen bond with the polymer of the polymer matrix but does not form a chemical bond such as a covalent bond, gas permeability may be additionally improved while maintaining gas selectivity.

Meanwhile, referring to Comparative Examples 5 and 6, as the addition amount of the polymer is reduced by half, the thickness is similar to that of Example 1, in which the addition amount of the polymer is double, and the membrane is manufactured by mixing 100 parts by weight of the polymer and 100 parts by weight of the alkylene glycol-based oligomer, and then the alkylene glycol-based oligomer is removed. Therefore, by comparing Comparative Examples 5 and 6 with Example 1, it can be confirmed whether the effect of improving the CO₂ permeability of Example 1 is due to the thickness reduction. However, since it can be seen that the CO₂ permeability of Example 1 is improved by 3.2 times and 1.6 times compared to Comparative Example 5 and Comparative Example 6, respectively, it can be confirmed that the effect of improving the CO₂ permeability of Example 1 is not due to the thickness reduction.

Referring to Comparative Examples 7 to 9 and Examples 2 to 4, changes in CO₂ permeability according to the addition amount of the alkylene glycol-based oligomer may be compared. It can be confirmed that the CO₂ permeability of Example 1, in which the addition amount of the alkylene glycol-based oligomer is 100 parts by weight, is the most excellent, and in the case of Example 4, in which the addition amount of the alkylene glycol-based oligomer is 500 parts by weight, the CO₂ permeability is greater than 7,000 GPU, so it is presumed that the polymer concentration for forming the composite membrane is insufficient.

Referring to Example 1 and Examples 5 to 8, the effects according to changes in the solvent immersion time can be seen. According to this, it can be seen that the relationship of the CO₂ permeability improvement according to the solvent immersion time is small. This appears to be because the removal process of the alkylene glycol-based oligomer occurs within a very short time, indicating that it may be applicable to a large-area coating process.

Example 9 and Comparative Example 10 are cases where polydimethylsiloxane (PDMS) is used as the intermediate layer and a surface of the intermediate layer is subjected to plasma treatment. Referring to Example 9 and Comparative Example 10, in the case of Example 9, the improvement in CO₂ permeability is slightly reduced compared to Example 1, which is presumed to be due to interfacial characteristics between the intermediate layer and the composite membrane.

Although preferred embodiments have been described in detail above, the scope of rights is not limited thereto, and various modifications and improvements by those skilled in the art using the basic concept defined in the following claims also belong to the scope of rights.

What is claimed is:

1. A separation membrane comprising:
a polymer matrix comprising
a polymer comprising a first segment and a second segment having phase separation from each other, and
a plurality of pores; and
an alkylene glycol oligomer positioned in the pores of the polymer matrix,
wherein the alkylene glycol oligomer comprises an alkylene oxide repeat unit substituted with a heterocyclic group comprising oxygen.

2. The separation membrane of claim 1,
wherein the heterocyclic group comprising oxygen of the alkylene glycol oligomer comprises an epoxy group, an oxetane group, tetrahydrofuran, 1,3-dioxolane, 1,4-dioxane, tetrahydropyran, or a combination thereof.

3. The separation membrane of claim 1,
wherein the alkylene oxide repeat unit of the alkylene glycol oligomer comprises an ethylene oxide repeat unit, an n-propylene oxide repeat unit, an iso-propylene oxide repeat unit, an n-butylene repeat unit, or a combination thereof.

4. The separation membrane of claim 1,
wherein the alkylene glycol oligomer is a compound represented by Chemical Formula 1: 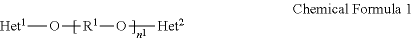
wherein
R¹ is an alkylene group,
Het¹ and Het² are each independently a heterocyclic group comprising oxygen, and
n¹ is the number of repetitions of the repeat unit, and is an integer of 1 to 100.

5. The separation membrane of claim 4,
wherein the alkylene glycol oligomer is a compound represented by Chemical Formula 1-1, 1-2, or 1-3: 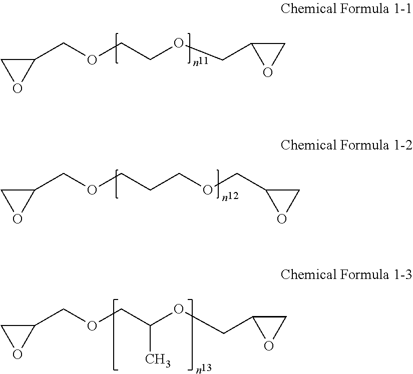
wherein
n¹¹ to n¹³ are the number of repetitions of each repeat unit, and are each independently an integer of 1 to 100.

6. The separation membrane of claim 1,
wherein the separation membrane comprises the alkylene glycol oligomer in an amount of greater than 0 weight percent and less than or equal to 10 weight percent, based on the total weight of the separation membrane.

7. The separation membrane of claim 1,
wherein a weight average molecular weight of the alkylene glycol oligomer is 250 grams per mole to 1,000 grams per mole.

8. The separation membrane of claim 1,
wherein the polymer of the polymer matrix comprises poly(ethylene oxide)-block-poly(butylene terephthalate), polyethylene oxide-block-polyamide, poly(tetramethylene oxide)-block-polyamide, poly(acrylonitrile)-random-poly(ethylene glycol) methyl ether methacrylate, or a combination thereof.

9. The separation membrane of claim 1,
wherein the polymer of the polymer matrix is a compound represented by Chemical Formula 2: 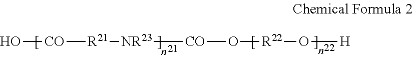
wherein
R²¹ and R²² are each independently an alkylene group,
R²³ is a hydrogen group or an alkyl group,
n²¹ and n²² are molar ratios of respective repeat units, a sum of n²¹ and n²² is 100, n²¹ is an integer of 10 to 60, and n²² is an integer of 40 to 90.

10. A separation membrane comprising:
a polymer matrix comprising
a polymer comprising a first segment and a second segment having phase separation from each other, and
a plurality of pores,
wherein a d-spacing, which is an average spacing between phase separation domains measured by Small Angle X-ray Scattering (SAXS) analysis, is less than 15.43 nanometers.

11. The separation membrane of claim 10,
wherein the d-spacing measured by the Small Angle X-ray Scattering analysis of the separation membrane is greater than 10.58 nanometers and less than 15.43 nanometers.

12. The separation membrane of claim 10,
wherein the separation membrane has a degree of crystallinity (X_{c}) of greater than or equal to 1.0% and less than 13.05%, calculated by Equation 1 using a result measured by differential scanning calorimetry (DSC):
X_{c}=ΔHₘ/ΔH_{m,0}×100% Equation 1
wherein
Δ Hₘ is a melting enthalpy calculated from an area of a melting peak of a sample in the DSC result, and
Δ H_{m,0} is a theoretical melting enthalpy of a 100% crystalline polymer.

13. The separation membrane of claim 10,
wherein the separation membrane has a fractional free volume (FFV) calculated by Equation 2 of greater than 0.115:
FFV=1−1.3·V_{ω}·ρ Equation 2
wherein V_{ω} is a van der Waals volume of a repeat unit of the polymer, and ρ is a density of the polymer.

14. The separation membrane of claim 10,
wherein the polymer of the polymer matrix is a compound represented by Chemical Formula 2: 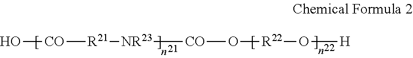
wherein
R²¹ and R²² are each independently an alkylene group,
R²³ is hydrogen or an alkyl group,
n²¹ and n²² are molar ratios of respective repeat units, a sum of n²¹ and n²² is 100, n²¹ is an integer of 10 to 60, and n²² is an integer of 40 to 90.

15. The separation membrane of claim 10,
wherein the separation membrane further comprises an alkylene glycol oligomer positioned in the pores of the polymer matrix, and
the alkylene glycol oligomer comprises an alkylene oxide repeat unit substituted with a heterocyclic group comprising oxygen.

16. A composite membrane comprising:
a porous support layer;
an intermediate layer positioned on the porous support layer; and
a separation membrane positioned on the intermediate layer,
wherein the separation membrane is the separation membrane according to claim 1.

17. The composite membrane of claim 16,
wherein the intermediate layer comprises polydimethylsiloxane (PDMS), poly(trimethylsilyl)propyne (PTMSP), or a combination thereof, and
the intermediate layer comprises a hydroxy radical (—OH) on a surface in contact with the separation membrane.

18. A method of manufacturing a separation membrane, comprising:
preparing a mixture by mixing a polymer comprising a first segment and a second segment having phase separation from each other with an alkylene glycol oligomer;
forming a membrane using the mixture; and
contacting the membrane with a solvent to remove at least a portion of the alkylene glycol oligomer to form a polymer matrix having a plurality of pores,
wherein the alkylene glycol oligomer comprises an alkylene oxide repeat unit substituted with a heterocyclic group comprising oxygen.

19. The method of manufacturing the separation membrane of claim 18,
wherein the mixture comprises 10 parts by weight to 500 parts by weight of the alkylene glycol oligomer based on 100 parts by weight of the polymer,
wherein the solvent comprises water, methanol, ethanol, propanol, butanol, or a combination thereof, or
a combination thereof.

20. A separation membrane comprising:
a polymer matrix comprising
a polymer comprising a first segment and a second segment having phase separation from each other, and
a plurality of pores; and
an alkylene glycol oligomer positioned in the pores of the polymer matrix,
wherein the alkylene glycol oligomer is a compound represented by Chemical Formula 1-3 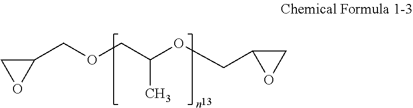
wherein n¹³ is an integer of 1 to 100,
wherein the separation membrane comprises the alkylene glycol oligomer in an amount of greater than 0 weight percent and less than or equal to 10 weight percent, based on the total weight of the separation membrane, and
wherein the polymer of the polymer matrix comprises polyethylene oxide-block-polyamide.
